(19) United States
(12) Patent Application Publication
(10) Pub. No.: US 2022/0262172 A1
(43) Pub. Date: Aug. 18, 2022

(54) Method and System for Detecting Tampering in a Vehicle

(71) Applicant: Bayerische Motoren Werke Aktiengesellschaft, Muenchen (DE)

(72) Inventors: Sigmund BECKER, Friedberg (DE); Daniel KRETSCHMANN, Markt Schwaben (DE); Tobias KUHN, Unterschleissheim (DE); Ingrid PREM, Muenchen (DE); Alexander SCHEEL, Muenchen (DE); Alexander SCHLENK, Muenchen (DE); Martin STENGL, Oberschleissheim (DE); Martin WOZNIAK, Muenchen (DE)

(21) Appl. No.: 17/626,405

(22) PCT Filed: Jul. 10, 2020
(86) PCT No.: PCT/EP2020/069653

§ 371 Date: Jan. 11, 2022

(30) Foreign Application Priority Data
Jul. 22, 2019 (DE) 10 2019 119 784.8

(51) Int. Cl. G07C 5/00; G07C 5/08; G01C 22/02

(52) U.S. Cl. CPC G07C 5/008; G01C 22/02; G07C 5/085; G07C 5/0808

(57) ABSTRACT

A method for detecting tampering in a vehicle includes receiving first data of a first type in a central unit; receiving second data of a second type in the central unit, wherein the first type and the second type are different, and the first data and the second data relate to the operation of the vehicle; and checking the first data and the second data for mutual correspondence.

### BACKGROUND AND SUMMARY OF THE INVENTION

The present disclosure relates to a method for detecting tampering in a vehicle, a storage medium for performing the method and a system for detecting tampering in a vehicle. The present disclosure in particular relates to the reliable detection of tampering in a vehicle, such as for example tampering with a mileage and/or illegal tuning.

The mileage and/or performance of vehicles can be tampered with by their owners/drivers, for example in order to save leasing costs or to use more power. This can be done illegally and e.g. lead to warranty costs on account of overworking of the engine and the vehicle, nonobservance of service intervals, increased CO₂ emissions, lower residual vehicle value and loss of operating licence. By way of example, there are “service providers” that offer “mileage correction”. The challenge is to reliably detect such tampering.

Data stored in the vehicle can be evaluated by way of diagnostic processes, for example. Only simple tampering can be detected on the basis of these data, however. As such, gradual mileage increase (“half the clock”) is not detectable, for example. Moreover, signs of tampering can be covered up by removing hardware or erasing the error memory. Even simply reading off the displayed mileage and transmitting it to a central office is unsuitable for detecting continuous tampering or repression of mileage recording (e.g. half the clock or clock off). Detection of vehicle tampering is therefore not possible with sufficient certainty.

It is an object of the present disclosure to specify a method for detecting tampering in a vehicle, a storage medium for performing the method and a system for detecting tampering in a vehicle that allow reliable detection of tampering in a vehicle. In particular, it is an object of the present disclosure to detect tampering with a mileage and/or illegal tuning of the vehicle.

This object is achieved by the claimed invention.

According to an independent aspect of the present disclosure, a method for detecting tampering in a vehicle, in particular a motor vehicle, is specified. The method comprises receiving first data of a first type in a central unit; receiving second data of a second type in the central unit, the first type and the second type being able to be different or being different, and the first data and the second data relating to operation of the vehicle; and checking at least the first data and the second data for consistency.

Preferably, the method further comprises determining that the vehicle has been tampered with if the first data and the second data are not consistent, and determining that the vehicle has not been tampered with if the first data and the second data are consistent.

According to exemplary embodiments of the invention, for example at least two different data types are compared, tampering being able to be discovered if the data are not consistent, that is to say do not match. By way of example, the data of the first type may indicate a mileage of the vehicle, and the data of the second type may indicate a geoposition of the vehicle, and in particular a history of the geoposition. If the mileage indicates 1000 km, but the vehicle has repeatedly travelled between Munich and Hamburg, it can be inferred that the mileage has been tampered with, since the data are not consistent. The comparison of at least two different data types allows tampering to be detected more certainly and more reliably.

According to some embodiments of the present disclosure, two different datasets, namely the first data of the first type and the second data of the second type, are examined for consistency. The present disclosure is not restricted to this, however, and it is possible to use more than two datasets of two or more different types for the method according to embodiments of the invention. By way of example, the first data of the first type and the second data of the second type, and also third data of the first type or of the second type or of a third type, which is different than the first and second types, can be used for the method according to embodiments of the invention.

Within the context of the present disclosure, the terms “type” and “data type” relate to a nature and/or a content of data. In some embodiments, the data type can relate to a vehicle parameter, such as for example a mileage, an engine speed, a geoposition, etc. Different data types can therefore relate to different or different types of vehicle parameters, such as for example a mileage and a geoposition. By contrast, identical or similar data types would relate to the same or the identical vehicle parameters, such as for example a mileage.

Within the context of the present disclosure, the term “consistency” relates to matching or corresponding data or datasets. In particular, consistency exists if there is no conflict between the data or datasets, i.e. if the data or datasets are plausible when viewed together.

The check on consistency can for example ascertain a direct or indirect relationship between the first data and the second data. If the direct or indirect relationship is outside a predetermined framework, i.e. if the direct or indirect relationship is equal to or greater than a predetermined deviation, then it can be inferred that the data are not consistent (i.e. tampering has occurred). On the other hand, if the direct or indirect relationship is within a predetermined framework, i.e. if the direct or indirect relationship is equal to or less than a predetermined deviation, then it can be inferred that the data are consistent (i.e. no tampering has occurred). In some embodiments, erroneous (sporadic) values can be filtered out before the check on consistency. The erroneous values can result from an error in the vehicle and/or an error during transfer, for example.

The direct or indirect relationship between the data or datasets may be defined in a suitable manner. By way of example, the direct or indirect relationship can be ascertained empirically. In another example, the direct or indirect relationship may be a logic relationship and/or a mathematical relationship. By way of example, a fuel consumption for a given number of kilometers travelled has to be plausible.

According to the embodiments, the first data and/or the second data can be collected continuously and/or via different channels and transmitted to the central unit. By way of example, the first data and the second data are provided by the vehicle. In one example, the first data and/or the second data are transmitted “over the air” e.g. with data from the Connected Drive services such as Last State Call (LSC) and Teleservices.

In some embodiments, the first data and/or the second data can be transmitted to the central unit directly or indirectly. A direct transmission can take place by way of a communication module of the vehicle, for example. The communication module may be designed to communicate with the central unit wirelessly in a mobile network via local area networks (LANs), such as e.g. Wireless LAN (WiFi/WLAN), or via wide area networks (WANs), such as e.g. Global System for Mobile Communication (GSM), General Packet Radio Service (GPRS), Enhanced Data Rates for Global Evolution (EDGE), Universal Mobile Telecommunications System (UMTS), High Speed Downlink/Uplink Packet Access (HSDPA, HSUPA), Long-Term Evolution (LTE), or World Wide Interoperability for Microwave Access (WIMAX). Communication using other current or future communication technologies, e.g. 5G mobile radio systems, is possible.

An indirect transmission can take place by way of an intermediary. By way of example, during a workshop visit, data can be read or picked up and transmitted to the central unit. The data can be read or picked up electronically, such as for example using a mobile terminal of a service engineer, which communicates with the vehicle wirelessly or by wire.

In some embodiments, the first data and the second data can come from different sources in the vehicle. The first data and the second data can be collected, compared and processed in order to detect tampering on an ad hoc basis and to transmit the result to the back end. This can in particular be done using CDC (Crowd Data Collector), where scripts can be installed in the vehicle that check for tampering according to rules in the vehicle and transmit the result.

In other embodiments, the first data can be provided by the vehicle and the second data can be provided by at least one unit other than the vehicle. The at least one other unit may be another vehicle, for example, and in particular a vehicle of a vehicle fleet. A vehicle fleet is understood to mean a fleet of identical or similar vehicles. A fleet can comprise vehicles of the same type with determined motorization, for example. As a result, it is possible to ensure that the first data and the second data are compatible and tampering can be detected reliably. The first data and/or the second data can be provided via direct or indirect paths, as described above.

As mentioned previously, the embodiments of the present disclosure are not restricted to the examination of two datasets, and it is possible to use three or more datasets of two or more types to detect tampering. By way of example, the fleet may have predefined a determined fuel consumption or a fuel consumption range for a determined route, such as e.g. a determined section on a freeway. If the vehicle for which the tamper check is carried out consumes significantly more fuel for the same section, it can be inferred that tuning has occurred, for example.

The first data and/or the second data are preferably provided cyclically. In particular, the first data and/or the second data can be provided at determined intervals. The determined intervals may be time intervals (e.g. every three minutes) and/or distance intervals (e.g. every three kilometers), for example.

The first data and/or the second data are preferably collected over a predetermined period of time. In other words, a vehicle history can be recorded. By way of example, the tamper check can be performed on continually growing datasets as time goes by. In particular, tamper detection can be performed by way of analytical processing of all historicized data from the central unit that are available for a vehicle. This allows the reliability of the tamper check to be increased.

The first data and the second data are preferably selected from a group that comprises the following, or that consists thereof:

data regarding a mileage of the vehicle (e.g. total mileage and/or mileage for a determined route or a determined driving time); and/or

data regarding a geoposition of the vehicle (e.g. a GPS position); and/or

data regarding a fuel consumption of the vehicle (e.g. gas, petrol); and/or

data regarding a power consumption of the vehicle (e.g. of a drive energy store of an electric or hybrid vehicle and/or of a vehicle electrical system); and/or

data regarding wheel revolutions of the vehicle; and/or

data regarding error messages in the vehicle (e.g. relating to the detection of installation of unauthorized components).

In some embodiments, the tampering that can be detected using the embodiments of the present disclosure is tampering with an odometer reading and/or tuning of the vehicle.

The term “tuning” refers to individual alteration and modification for the purposes of enhancing performance and/or improving driving properties. The term “tuning” refers in particular to alteration of the engine, the aerodynamics of a bodywork or the chassis to enhance performance.

According to an independent aspect of the present disclosure, which can be combined with the aspects mentioned above, a method for detecting tampering in a vehicle, in particular a motor vehicle, is specified. The method comprises receiving first data of a first type in a central unit; historicizing the first data over time; receiving second data of the first type in the central unit; and checking at least the historicized first data and the second data for consistency.

This allows simple tampering to be detected just on the basis of one data type by way of historicization, such as for example sudden mileage changes based on a reliable mileage value from a single control unit historicized over time.

The term vehicle covers automobiles, trucks, buses, motor caravans, motorcycles, etc. used for conveying people, goods, etc. The term in particular covers motor vehicles for conveying people.

According to another aspect of the present disclosure, a storage medium containing a software program is provided. The software program is designed to be executed on one or more processors and thereby to perform the method for detecting tampering in a vehicle that is described in this document.

According to another independent aspect of the present disclosure, a system for detecting tampering in a vehicle is specified. The system comprises a receiving unit for receiving first data of a first type and second data of a second type, the first type and the second type being different, and the first data and the second data relating to operation of the vehicle, and a processor unit designed to check at least the first data and the second data for consistency.

The system may be implemented in a central unit, and in particular a back end. The back end may be a back end of a vehicle manufacturer, for example. As a result, it is possible to ensure that the evaluation of the data cannot be influenced by third parties, such as for example by the owner of the vehicle, who has carried out the tampering.

In some embodiments, some or all of the system may be implemented in the vehicle.

The system can include aspects that are described in connection with the method of the present disclosure. Similarly, the method can implement the aspects described in connection with the system.

Exemplary embodiments of the disclosure are depicted in the figures and are described in more detail below.

### BRIEF DESCRIPTION OF THE DRAWINGS

FIG. 1 schematically shows a flowchart for a method for detecting tampering in a vehicle according to embodiments of the present disclosure.

FIG. 2 schematically shows a system for detecting tampering in a vehicle according to embodiments of the present disclosure.

FIG. 3 schematically shows a system for detecting tampering in a vehicle according to further embodiments of the present disclosure.

FIG. 4 schematically shows types of tampering that can be detected using the embodiments of the present disclosure.

### DETAILED DESCRIPTION OF THE DRAWINGS

Unless stated otherwise, identical reference signs are used below for elements that are identical and have an identical effect.

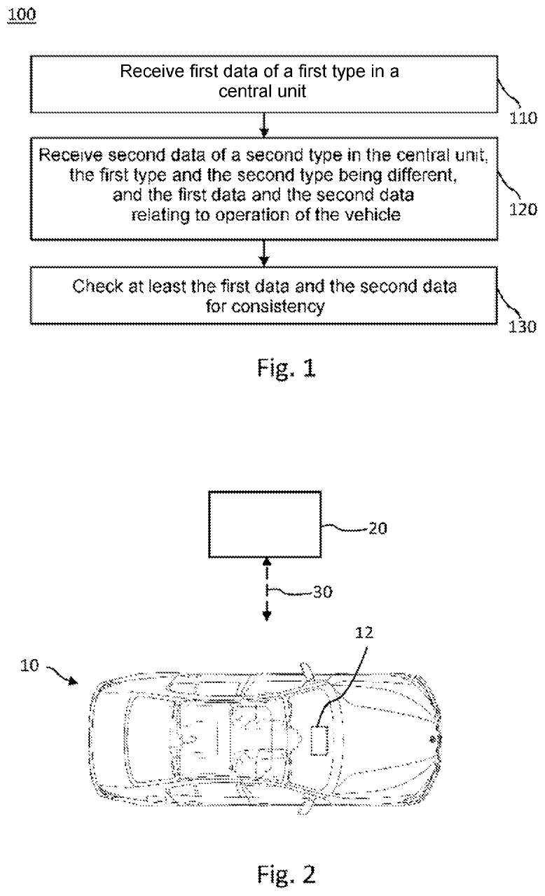

FIG. 1 schematically shows a flowchart for a method 100 for detecting tampering in a vehicle, in particular a motor vehicle, according to embodiments of the present disclosure.

The method 100 comprises receiving first data of a first type in a central unit in block 110; receiving second data of a second type in the central unit in block 120, the first type and the second type being different, and the first data and the second data relating to operation of the vehicle; and checking at least the first data and the second data for consistency in block 130. Blocks 110 and 120 can be performed sequentially or in parallel. By way of example, data from different sources are first collected in parallel or processed collectively on an ad hoc basis.

In some embodiments, the method 100 further comprises determining that the vehicle has been tampered with if the first data and the second data are not consistent, and determining that the vehicle has not been tampered with if the first data and the second data are consistent. This determination can be performed by the central unit, and in particular by a suitable piece of software.

In some embodiments, the tampering that can be detected using the embodiments of the present disclosure is tampering with an odometer reading and/or tuning of the vehicle.

The first data and the second data can comprise for example data regarding a mileage of the vehicle (e.g. total mileage and/or for a determined route or driving time), data regarding a geoposition of the vehicle (e.g. a GPS position), data regarding a fuel consumption of the vehicle (e.g. gas, petrol), data regarding a power consumption of the vehicle (e.g. of a drive energy store of an electric or hybrid vehicle and/or of a vehicle electrical system), data regarding wheel revolutions of the vehicle, and/or data regarding error messages in the vehicle (e.g. relating to the detection of installation of unauthorized components).

The present disclosure is not restricted to the first data and the second data, and more than two datasets of two or more different types can be used for the method 100. By way of example, the first data of the first type and the second data of the second type, and also third data of the first type or of the second type or of a third type, which is different than the first and second types, can be used for the method 100 according to embodiments of the invention.

The check on consistency in block 130 can take place via a direct or indirect relationship between the first data and the second data, for example. If the direct or indirect relationship is outside a predetermined framework, i.e. if the direct or indirect relationship is equal to or greater than a predetermined deviation, then it can be inferred that the data are not consistent (i.e. tampering has occurred). By way of example, a fuel consumption for a determined number of kilometers travelled may be implausible, as a result of which it can be inferred that the mileage has been tampered with, for example.

On the other hand, if the direct or indirect relationship is within a predetermined framework, i.e. if the direct or indirect relationship is equal to or less than a predetermined deviation, then it can be inferred that the data are consistent (i.e. no tampering has occurred). By way of example, a fuel consumption for a determined number of kilometers travelled may be plausible, as a result of which it can be inferred that the mileage is correct, for example.

FIG. 2 schematically shows a system for detecting tampering in a vehicle 10 according to embodiments of the present disclosure.

The system comprises a receiving unit for receiving first data of a first type and second data of a second type, the first type and the second type being different, and the first data and the second data relating to operation of the vehicle 10, and a processor unit designed to check at least the first data and the second data for consistency.

The system may be implemented in a central unit 20, and in particular a back end. The back end may be a back end of a vehicle manufacturer, for example. As a result, it is possible to ensure that the evaluation of the data cannot be influenced by third parties, such as for example by the owner of the vehicle 10, who has carried out the tampering.

In some embodiments, the first data and/or the second data can be transmitted to the central unit 20 directly or indirectly. A direct transmission can take place by way of a communication module 12 of the vehicle 10, for example, which is designed to communicate with the central unit 20 either directly or indirectly by way of a communication connection 30. The communication between the vehicle 10 and the central unit 20 can take place via a mobile network, for example.

An indirect transmission (not shown) can take place by way of one or more intermediaries. By way of example, during a workshop visit, data can be read or picked up and transmitted to the central unit 20 by way of a different communication connection than the communication connection 30 shown in FIG. 2. The data can be read or picked up electronically, such as for example using a mobile terminal of a service engineer, which communicates with the vehicle 10 wirelessly or by wire.

In some embodiments, the first data and/or the second data are provided cyclically. In particular, the first data and/or the second data can be provided at determined intervals, such as for example at determined time intervals (e.g. every three minutes) and/or distance intervals (e.g. every three kilometers).

The first data and/or the second data can be provided automatically or as a reaction to a trigger. By way of example, it is possible to trigger the relevant vehicles to transmit applicable data cyclically (campaign management) or to request said data when required.

The first data and/or the second data are typically collected over a (pre)determined period of time. The predetermined period of time can begin at a time of manufacture of the vehicle, for example. The present disclosure is not restricted to this, however, and it is possible to define any periods of time that include a suitable vehicle history for detecting tampering.

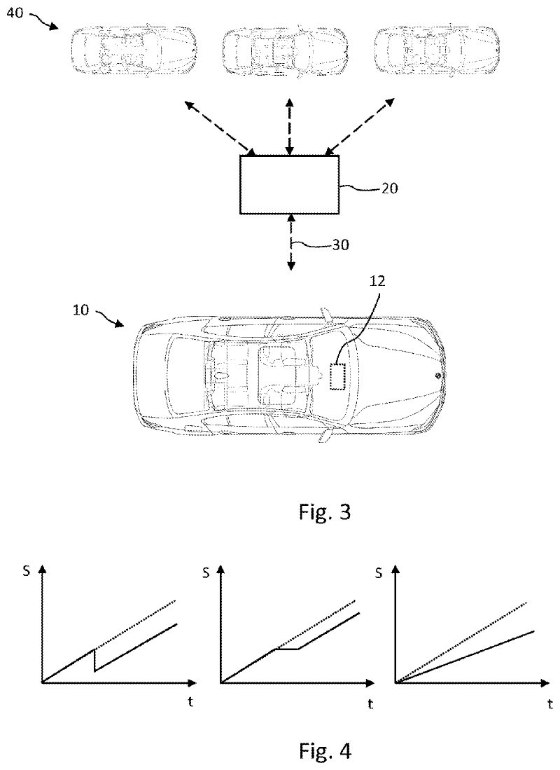

FIG. 3 schematically shows a system for detecting tampering in a vehicle 10 according to further embodiments of the present disclosure.

In the embodiment shown in FIG. 3, the first data and/or the second data and/or further data for checking for tampering are provided by a vehicle fleet 40. By way of example, the fleet 40 may have predefined a determined fuel consumption or a fuel consumption range for a determined route, such as e.g. a determined section on a freeway. If the vehicle for which the tamper check is carried out consumes significantly more fuel for the same section, it can be inferred that tuning has occurred, for example.

FIG. 4 schematically shows types of tampering that can be detected using the embodiments of the present disclosure.

The graphs in FIG. 4 indicate a time t on the x-axis and a mileage S on the y-axis. There is a sudden change on the left in FIG. 4, there is an interruption (flatline) in the middle of FIG. 4, and there is a change of gradient on the right in FIG. 4. The embodiments of the present disclosure can be used to detect all three types of tampering individually and in combination.

According to embodiments of the invention, for example at least two different data types are compared, tampering being able to be discovered if the data are not consistent, that is to say do not match. By way of example, the data of the first type may indicate a mileage of the vehicle, and the data of the second type may indicate a geoposition of the vehicle, and in particular a history of the geoposition. If the mileage indicates 1000 km, but the vehicle has repeatedly travelled between Munich and Hamburg, it can be inferred that the mileage has been tampered with, since the data are not consistent. The comparison of at least two different data types allows tampering to be detected more certainly and more reliably.

1.-11. (canceled)

12. A method for detecting tampering in a vehicle, the method comprising:
receiving first data of a first type in a central unit;
receiving second data of a second type in the central unit, the first type and the second type being different, and the first data and the second data relating to operation of the vehicle; and
checking at least the first data and the second data for consistency with one another.

13. The method according to claim 12, further comprising:
determining that the vehicle has been tampered with if the first data and the second data are not consistent; or
determining that the vehicle has not been tampered with if the first data and the second data are consistent.

14. The method according to claim 12, wherein:
the first data and the second data are provided by the vehicle; or
the first data are provided by the vehicle and the second data are provided by at least one unit other than the vehicle.

15. The method according to claim 12, wherein at least one of the first data or the second data is provided cyclically.

16. The method according to claim 12, wherein at least one of the first data or the second data is collected over a period of time in order to create a vehicle history in the central unit.

17. The method according to claim 12, wherein the first data and the second data are selected from the group consisting of:
data regarding a mileage;
data regarding a geoposition;
data regarding a fuel consumption;
data regarding a power consumption;
data regarding wheel revolutions; and
data regarding error messages.

18. The method according to claim 12, wherein the tampering is tampering with an odometer reading or tuning of the vehicle.

19. A computer product comprising a non-transitory computer readable medium having stored thereon program code which, when executed on one or more processors, carries out the method according to claim 12.

20. A system for detecting tampering in a vehicle, the system comprising:
a receiver unit for receiving first data of a first type and second data of a second type, the first type and the second type being different, and the first data and the second data relating to operation of the vehicle; and
a processor that is configured to check at least the first data and the second data for consistency with one another.

21. The system according to claim 20, wherein the system is configured to perform a method comprising:
receiving first data of a first type in a central unit;
receiving second data of a second type in the central unit, the first type and the second type being different, and the first data and the second data relating to operation of the vehicle; and
checking at least the first data and the second data for consistency with one another.

22. A method for detecting tampering in a vehicle, the method comprising:
receiving first data of a first type in a central unit;
historicizing the first data over time;
receiving second data of the first type in the central unit; and
checking at least the historicized first data and the second data for consistency.

23. The method according to claim 22, wherein the vehicle is a motor vehicle.
